(19) United States
(12) Patent Application Publication
(10) Pub. No.: US 2013/0309434 A1
(43) Pub. Date: Nov. 21, 2013

(54) RELEASE AGENT, RELEASE MATERIAL, AND ADHESIVE TAPE

(71) Applicants: Tsuyoshi Hiramatsu, Ibaraki-shi (JP); Yuji Toyota, Ibaraki-shi (JP)

(72) Inventors: Tsuyoshi Hiramatsu, Ibaraki-shi (JP); Yuji Toyota, Ibaraki-shi (JP)

(73) Assignee: NITTO DENKO CORPORATION, Ibaraki-shi, Osaka (JP)

(21) Appl. No.: 13/983,403

(22) PCT Filed: Jan. 20, 2012
(86) PCT No.: PCT/JP2012/051216

§ 371 Date: Aug. 2, 2013

(30) Foreign Application Priority Data
Feb. 4, 2011 (JP) 2011-023219
Sep. 14, 2011 (JP) 2011-201171
Jan. 13, 2012 (JP) 2012-005041

(51) Int. Cl. C09J 123/08; C09J 7/02; C09J 175/14

(52) U.S. Cl. CPC C09J 123/0807; C09J 123/0815; C09J 175/14; C09J 7/0228
USPC 428/40.9; 524/507; 428/352

(57) ABSTRACT

The present invention provides a release agent containing polyolefin, isocyanate, polyolefin polyol and a metal complex catalyst, wherein the metal complex catalyst is a non-organotin compound.

### TECHNICAL FIELD

The present invention relates to a release agent containing polyolefin (hereinafter sometimes to be abbreviated as a “polyolefin-based release agent”), and a release material and an adhesive tape having a release agent layer formed from the release agent.

### BACKGROUND ART

Release material is made of a substrate such as paper, plastic film and plastic laminated paper and the like and a release agent layer formed on at least one surface of the substrate, and is used for protecting the adhesive surface of an adhesive tape, an adhesive sheet, a label and the like, and for the production step of a ceramic green sheet and the like.

The release agent is known a silicone-based release agent, a long-chain alkyl release agent, a polyolefin-based release agent, a fluorinated release agent and the like. For use such as application related to electronic component and the like, since a silicone-based release agent may cause a problem, a non-silicone-based release agent such as a polyolefin-based release agent and the like is used.

To improve adhesiveness of a polyolefin-based release agent to a substrate, an isocyanate-based crosslinking agent and polyol are sometimes used in a polyolefin-based release agent (e.g., patent documents 1-3). Furthermore, to promote a urethane reaction of an isocyanate-based crosslinking agent and polyol, a urethane catalyst is sometimes added. As a urethane catalyst, organotin compounds such as dibutyltin dilaurate, dioctyltin dilaurate and the like have been frequently used. Organotin compounds have good solubility in organic solvents, high catalyst activity, and further, a small influence on the release force of a release agent layer. Therefore, using an organotin compound, a release agent layer superior in the appearance and adhesion to a substrate can be formed.

### DOCUMENT LIST

### Patent Documents

patent document 1: JP-A-2004-346213
patent document 2: JP-A-2004-250681
patent document 3: JP-A-2004-230773

### SUMMARY OF THE INVENTION

### Problems to be Solved by the Invention

However, as the attention to the environment problems increases in recent years, the use of organotin compounds tends to be limited more and more. Thus, a release agent free of an organotin compound is desired. The present invention has been made taking note of such situation, and aims to provide, without using an organotin compound, a release agent capable of forming a release agent layer superior in the adhesion to a substrate and having good appearance.

### Means of Solving the Problems

The present inventors have conducted intensive studies and found that the above-mentioned object can be achieved by using a metal complex of a non-organotin compound as a urethane catalyst, which resulted in the completion of the present invention. The present invention provides the following.

[1] A release agent comprising polyolefin, isocyanate, polyolefin polyol and a metal complex catalyst, wherein the metal complex catalyst is a non-organotin compound.
[2] The release agent of the above-mentioned [1], wherein the metal complex catalyst has an organic ligand.
[3] The release agent of the above-mentioned [2], wherein the metal complex catalyst is a metal chelate catalyst.
[4] The release agent of any one of the above-mentioned [1] to [3], wherein the metal complex catalyst is at least one selected from the group consisting of a titanium complex catalyst, a zinc complex catalyst, a zirconium complex catalyst, an aluminum complex catalyst and an iron complex catalyst.
[5] The release agent of any one of the above-mentioned [1] to [4], wherein the isocyanate is polyisocyanate having 3 or more isocyanate groups in one molecule.
[6] The release agent of the above-mentioned [5], wherein the polyisocyanate is at least one selected from the group consisting of aromatic polyisocyanate and alicyclic polyisocyanate.
[7] The release agent of the above-mentioned [6], wherein the polyisocyanate is at least one selected from the group consisting of an adduct of aromatic diisocyanate and polyvalent alcohol and an adduct of alicyclic diisocyanate and polyvalent alcohol.
[8] The release agent of any one of the above-mentioned [1] to [7], wherein the polyolefin polyol has a number-average molecular weight of 1500-50000.
[9] A release material having a substrate and a release agent layer, wherein the release agent layer is formed from the release agent of any one of the above-mentioned [1] to [8] and is formed on at least one surface of the substrate.
[10] An adhesive tape having an adhesive layer and the release material of the above-mentioned [9], wherein the adhesive layer is in contact with the release agent layer of the release material.
[11] An adhesive tape having a substrate, an adhesive layer and a release agent layer, wherein the release agent layer is formed from the release agent of any one of the above-mentioned [1] to [8] and is formed on at least one surface of the substrate, and the adhesive layer is formed on the other surface of the substrate free of the release agent layer.

### Effect of the Invention

Even though the release agent of the present invention does not contain an organotin compound, it can form a release agent layer superior in the adhesion to a substrate and having good appearance. In addition, the metal complex catalyst used in the present invention has a small influence on the release force of a release agent layer.

### DESCRIPTION OF EMBODIMENTS

### 1. Release Agent

The release agent of the present invention contains polyolefin, isocyanate, polyolefin polyol and a metal complex catalyst. These components are explained in order in the following.

### [Polyolefin]

The release agent of the present invention contains one or more kinds of polyolefin. The “polyolefin” in the present invention means a polyolefin which is solid at 38° C. As polyolefin, any can be used as long as it can be dissolved in an organic solvent together with other components and applied to a substrate.

From the aspect of solubility in an organic solvent, the density of polyolefin is preferably 0.885 g/cm³ or less, more preferably 0.880 g/cm³ or less. When the density exceeds 0.885 g/cm³, the solubility in organic solvents decreases, application to a substrate tends to be difficult, and a release force also tends to increase. On the other hand, while the lower limit of the density of polyolefin is not particularly set, it is preferably 0.830 g/cm³ or more, more preferably 0.857 g/cm³ or more, further preferably 0.858 g/cm³ or more.

Examples of the polyolefin include α-olefin copolymer formed from at least two monomers selected from the group consisting of ethylene, propylene and α-olefin having a carbon number of 4-20. Of these, a copolymer containing ethylene as a principal monomer (that is, ethylene-based α-olefin copolymer) and/or a copolymer having propylene as a principal monomer (that is, propylene-based α-olefin copolymer) are/is preferable. Here, examples of the α-olefin having a carbon number of 4-20 include 1-butene, 1-pentene, 3-methyl-1-butene, 1-hexene, 4-methyl-1-pentene, 3-methyl-1-pentene, 1-heptene, 1-octene, 1-decene, 1-dodecene and the like. In addition, the α-olefin copolymer may be any of a random copolymer, a block copolymer and a graft copolymer.

The density of the ethylene-based α-olefin copolymer is preferably not less than 0.857 g/cm³ and not more than 0.885 g/cm³ (more preferably 0.880 g/cm³ or less). The ethylene unit amount of the ethylene-based α-olefin copolymer is 50 mol % or more, preferably 60-95 mol %, more preferably 70-95 mol %. As the α-olefin unit contained in the ethylene-based α-olefin copolymer, one formed from at least one monomer selected from the group consisting of 1-butene, propylene, 1-hexene and 1-octene is preferable. Particularly preferable ethylene-based α-olefin copolymers are an ethylene-1-butene copolymer and an ethylene-propylene copolymer. Such ethylene-1-butene copolymer may contain a unit derived from α-olefin other than ethylene and 1-butene in an amount of 10 mol % or less. Likewise, the ethylene-propylene copolymer may contain a unit derived from α-olefin other than ethylene and propylene in an amount of 10 mol % or less. Such a copolymer can be produced by, for example, copolymerizing ethylene and an α-olefin using a catalyst consisting of a transition metal catalytic component (e.g., vanadium compounds, zirconium compounds) and an organic aluminum compound catalytic component.

The density of the propylene-based α-olefin copolymer is preferably not less than 0.858 g/cm³ and not more than 0.885 g/cm³ (more preferably 0.880 g/cm³ or less). The propylene unit amount of the propylene-based α-olefin copolymer exceeds 50 mol %. This propylene unit amount is preferably 60-95 mol %, more preferably 70-95 mol %. In addition, as the α-olefin unit contained in the propylene-based α-olefin copolymer, one formed from at least one monomer selected from the group consisting of ethylene, 1-butene, 1-hexene and 1-octene is preferable. A particularly preferable propylene-based α-olefin copolymer is a propylene-ethylene random copolymer (propylene-based elastomer). The propylene-ethylene random copolymer may contain a unit derived from α-olefin other than propylene and ethylene in an amount of 10 mol % or less. The propylene-based α-olefin copolymer can be produced by using a metallocene catalyst as described in, for example, JP-A-2000-191862.

As the α-olefin copolymer, a commercially available product can be used. Examples of preferable commercially available products of the ethylene-based α-olefin copolymer include TAFMER P series, TAFMER A series (all manufactured by Mitsui Chemicals, Inc.), ENGAGE (manufactured by Dow Chemical Company) and the like. In addition, examples of preferable commercially available products of the propylene-based α-olefin copolymer include TAFMER XM series (manufactured by Mitsui Chemicals, Inc.) and the like.

As polyolefin, polymethylpentene can also be used. Examples of polymethylpentene include a homopolymer of 4-methyl-1-pentene, and a copolymer of 4-methyl-1-pentene and other α-olefin. The 4-methyl-1-pentene unit amount of the polymethylpentene copolymer is preferably 50-95 mol %, more preferably 70-95 mol %. Polymethylpentene may also be a crystalline polymer. The density of polymethylpentene is preferably 0.83-0.86 g/cm³. As the α-olefin unit in the polymethylpentene copolymer, one derived from α-olefin having a carbon number of 2 to 20 such as ethylene, propylene, 1-butene, 1-hexene, 1-octene, 1-decene, 1-tetradecene, 1-octadecene and the like is preferable. Of these, 1-decene, 1-tetradecene and 1-octadecene showing good copolymerizability with 4-methyl-1-pentene are more preferable. Examples of a commercially available product of polymethylpentene include TPX-S (4-methylpentene-1-α-olefin copolymer, manufactured by Mitsui Chemicals, Inc.).

As polyolefin, diene-based rubbers such as polyisoprene, polybutadiene and the like can also be used as long as they are dissolved in an organic solvent. As such polyisoprene, one having a cis-1,4 bond in not less than 90%, a density of 0.90-0.92 g/cm³, and Mooney viscosity of 40-70 (ML1+4) at 100° C.) is preferable. Examples of a commercially available product of polyisoprene include IR-307 and IR-310 (manufactured by Kraton Performance Polymers Inc.). As polybutadiene, one having a cis-1,4 bond in not less than 90%, a density of 0.88-0.91 g/cm³, and Mooney viscosity of 25-50 (ML1+4 at 100° C.) is preferable. Examples of a commercially available product of polybutadiene include Nipol BR1220, Nipol BR1220L (manufactured by ZEON CORPORATION) and BR01 (manufactured by JSR).

It is preferable that the polyolefin in the present invention do not react with the isocyanates described below. A modified polyolefin having a functional group such as a hydroxy group, an amino group, a carboxy group, an isocyanate group (isocyanato group) and the like may be used as long as it is within the range not inhibiting the object of the present invention. The number of the functional group (average value) per molecule of the modified polyolefin is preferably not more than 1.

Particularly, when the release agent of the present invention is used in combination with an acrylic adhesive, an ethylene-based α-olefin copolymer and/or a propylene-based α-olefin copolymer are/is preferably used as olefin to prevent a time-course increase of a release force. On the other hand, when the release agent of the present invention is used for an application requiring a relatively large release force, a propylene-based α-olefin copolymer and/or polymethylpentene are/is preferable.

When only one polyolefin is used in the present invention, the MFR (melt flow rate) of polyolefin at 230° C. is preferably not more than 100 g/10 min, more preferably not more than 70 g/10 min, further preferably not more than 50 g/10 min, particularly preferably not more than 10 g/10 min, from the aspects of the stretch of the release agent layer to be formed (coated film strength) and the like.

When two or more polyolefins are used in the present invention, the MFR of at least one of them at 230° C. is preferably not more than 100 g/10 min, more preferably not more than 70 g/10 min, further preferably not more than 50 g/10 min, particularly preferably not more than 10 g/10 min. The content of polyolefin having such MFR is preferably not less than 10 wt %, more preferably not less than 50 wt %, further preferably not less than 90 wt %, of the whole polyolefin (that is, total of two or more polyolefins).

To decrease the release force and the peel rate dependency of the release agent layer, it is preferable to contain polyolefin (A-1) having a tensile modulus of elasticity of not more than 10 MPa at 23° C. and a tensile breaking stress of not more than 8 MPa at 23° C. in an amount of not less than 90 wt % of the whole polyolefin. In other words, the content of polyolefin (A-2) other than the aforementioned polyolefin (A-1) is preferably limited to 10 wt % or less of the whole polyolefin. Here, the peel rate dependency means that the release force of the release agent layer depends on the peel rate, more particularly, it means that the release force by high-speed peeling is larger than that by low-speed peeling.

Either one kind of the aforementioned polyolefin (A-1) and polyolefin (A-2) may be used or two or more kinds thereof may be used in combination. The content of polyolefin (A-1) is more preferably not less than 95 wt %, further preferably 100 wt %, of the whole polyolefin.

It is assumed the peel rate dependency decreases by the use of polyolefin (A-1) because, under the assumption that a fracture occurs near the interface between an adhesive layer and a release agent layer in a peeling process, an increase in the release force can be suppressed even when the peel rate becomes fast, since fracture occurs near the interface by a small force due to the presence of polyolefin (A-1) having a small tensile breaking stress.

The tensile modulus of elasticity of polyolefin (A-1) at 23° C. is not more than 10 MPa, preferably not more than 8 MPa, more preferably not more than 7 MPa, further preferably not more than 6 MPa. The tensile breaking stress of polyolefin (A-1) at 23° C. is not more than 8 MPa, preferably not more than 6 MPa, more preferably not more than 4 MPa. Polyolefin (A-2) having a tensile modulus of elasticity exceeding 10 MPa at 23° C. tends to increase release force of a release agent layer when peeled at a low speed and a high speed. Polyolefin (A-2) having a tensile breaking stress exceeding 8 MPa at 23° C. tends to increase release force of a release agent layer when peeled at a high speed.

Examples of polyolefin (A-2) include (i) a polyolefin having a tensile breaking stress at 23° C. of not more than 8 MPa and a tensile modulus of elasticity exceeding 10 MPa at 23° C.; (ii) a polyolefin having a tensile modulus of elasticity at 23° C. of not more than 10 MPa and a tensile breaking stress exceeding 8 MPa at 23° C.; and (iii) a polyolefin having a tensile modulus of elasticity exceeding 10 MPa at 23° C. and a tensile breaking stress exceeding 8 MPa at 23° C. Of these, polyolefin (A-2) of the embodiment of the aforementioned (ii) is preferable. In addition, the tensile modulus of elasticity of polyolefin (A-2) at 23° C. is preferably not more than 100 MPa, and the tensile breaking stress of polyolefin (A-2) at 23° C. is preferably not more than 35 MPa.

In the present invention, the lower limits of both the tensile modulus of elasticity at 23° C. and tensile breaking stress at 23° C. are not set for polyolefin (A-1). To obtain sufficient release agent layer strength (coated film strength), the tensile modulus of elasticity of polyolefin (A-1) at 23° C. is preferably not less than 2 MPa, more preferably not less than 3 MPa. The tensile breaking stress at 23° C. is preferably not less than 1 MPa, more preferably not less than 2 MPa.

The “tensile modulus of elasticity at 23° C.” and “tensile breaking stress at 23° C.” of polyolefin are values measured by the following methods.

Polyolefin is dissolved in toluene to give a 5-10 wt % solution, using a baker type applicator or doctor blade applicator, this is applied onto a poly(ethylene terephthalate) (PET) release film, and heat drying by a hot air dryer (100° C., 3 min). After heat drying, the film is immediately cooled under a 23° C. atmosphere to give a polyolefin film having a thickness of 20 μm after drying. When solubility in toluene is poor, it may be dissolved by heating as necessary. The obtained polyolefin film is cut into a rectangular strip (length 30 mm×width 100 mm), and closely wound in the longitudinal direction with one short side thereof as the axis, while peeling off from the release film, whereby a rod-like sample (length 30 mm) is obtained.

This rod-like sample is subjected to a tensile test under 23° C. atmosphere under the conditions of distance between chucks 10 mm and tension rate 50 mm/min by a tensile tester (manufactured by SHIMADZU CORPORATION, Autograph AG-IS type), and a stress-strain curve at that time is obtained. A tensile modulus of elasticity is calculated from the inclination of the curve immediately after start of tension in the stress-strain curve. In addition, the stress upon breakage of the rod-like sample is determined as a tensile breaking stress.

Examples of polyolefin (A-1) having a tensile modulus of elasticity at 23° C. of not more than 10 MPa and a tensile breaking stress at 23° C. of not more than 8 MPa include TAFMER P-0080K, TAFMER P-0280, TAFMER A-350705, TAFMER P-0680, TAFMER P-0180, TAFMER P-0480, TAFMER P-0275, TAFMER P-0775 (all ethylene-based α-olefin copolymers, manufactured by Mitsui Chemicals, Inc.) and the like.

The content of polyolefin is preferably 80-99 wt %, more preferably 90-98 wt %, in the release agent. When the content is less than 80 wt %, the release force markedly tends to become large. On the other hand, when the content exceeds 99 wt %, it is difficult to obtain sufficient strength of the release agent layer since the amount of crosslinking components is too small. The “release agent” to be the standard of the content does not contain the amount of an organic solvent.

### [Isocyanate]

The release agent of the present invention contains one or more kinds of isocyanates. Isocyanate may be any of aromatic isocyanate and aliphatic isocyanate. Aliphatic isocyanate may be any of chain aliphatic isocyanate and alicyclic isocyanate. Of these, aromatic isocyanate and alicyclic isocyanate are preferable. Since aromatic isocyanate and alicyclic isocyanate have low compatibility with polyolefin, even using these, the releasability of the release agent layer is not impaired. On the other hand, aromatic isocyanate and alicyclic isocyanate that are not compatible with polyolefin locally exist between a release agent layer to be formed and a substrate, and greatly contribute to the improvement of the adhesion of these.

To form a release agent layer superior in substrate adhesion and heat resistance, isocyanate is preferably a polyisocyanate having three or more isocyanate groups in one molecule, more preferably at least one selected from the group consisting of aromatic polyisocyanate and alicyclic polyisocyanate, further preferably at least one selected from the group consisting of an adduct of aromatic diisocyanate and polyvalent alcohol and an adduct of alicyclic diisocyanate and polyvalent alcohol.

Examples of aromatic diisocyanate include tolylene diisocyanate, diphenylmethane diisocyanate, 1,5-naphthylene diisocyanate, tolidine diisocyanate, xylylene diisocyanate, tetramethylxylylene diisocyanate and the like. Of these, tolylene diisocyanate and xylylene diisocyanate are preferable.

Examples of alicyclic diisocyanate include isophorone diisocyanate, hydrogenated xylylene diisocyanate, hydrogenated diphenylmethane diisocyanate, dimer acid diisocyanate, norbornane diisocyanate, trans-cyclohexane diisocyanate, hydrogenated tolylene diisocyanate and the like. Of these, isophorone diisocyanate and hydrogenated xylylene diisocyanate are preferable.

Examples of polyvalent alcohol include aliphatic polyvalent alcohol such as ethylene glycol, glycerin, trimethylol propane, pentaerythritol, ditrimethylol propane, dipentaerythritol and the like, and the like, with preference given to trimethylol propane.

Examples of polyisocyanate include a compound containing isocyanate groups on the terminals, which is obtained by reacting the aforementioned polyvalent alcohol with an excess amount of the aforementioned aromatic diisocyanate or the aforementioned alicyclic diisocyanate. In addition, a multimer of aromatic diisocyanate or alicyclic diisocyanate (e.g., isocyanurate form) is also preferable as polyisocyanate. The adduct of aromatic diisocyanate and polyvalent alcohol is preferably an adduct of tolylene diisocyanate or xylylene diisocyanate and polyvalent alcohol, more preferably an adduct of tolylene diisocyanate and polyvalent alcohol. The adduct of tolylene diisocyanate and polyvalent alcohol is superior in the reactivity and can achieve superior substrate adhesion. In addition, the adduct of alicyclic diisocyanate and polyvalent alcohol is preferably an adduct of hydrogenated xylylene diisocyanate or isophorone diisocyanate and polyvalent alcohol.

The content of isocyanate in the release agent is preferably 0.5-20 parts by weight, more preferably 1.0-15 parts by weight, further preferably 1.5-10 parts by weight, relative to 100 parts by weight of polyolefin. When isocyanate is used at such content, more superior adhesion to a substrate is achieved without an adverse influence of short pot life of the release agent and the like.

### [Polyolefin Polyol]

The release agent of the present invention contains one or more kinds of polyolefin polyols. Polyolefin polyol is used for a reaction with isocyanate when forming a release agent layer. Polyolefin polyol is preferably one having good compatibility with polyolefin.

The number average molecular weight (Mn) of polyolefin polyol is preferably 1500-50000, more preferably 1500-4000, further preferably 1500-3000. A polyolefin polyol having Mn in such range has appropriate solubility for both polyolefin and isocyanate. Therefore, such polyolefin polyol can improve the strength and heat resistance of a release agent layer and, on the other hand, does not impair appearance of the release agent layer. When Mn is outside the aforementioned range, a release agent layer with a white cloud appearance is sometimes obtained. Furthermore, when Mn is within the aforementioned range, a release agent layer having a small release force is obtained since a hydroxyl group derived from the polyolefin polyol is not present in excess in a release agent layer part on the side opposite from the substrate and where isocyanate is not localized. Furthermore, when Mn is within the aforementioned range, isocyanate and polyolefin polyol can react appropriately in a release agent layer part on the substrate side and where isocyanate is localized, whereby more superior adhesion to a substrate is obtained.

In the present invention, the kind of polyolefin polyol is not particularly limited. Examples thereof include polyethylene-based polyol, polypropylene-based polyol, polybutadiene polyol, hydrogenated polybutadiene polyol, polyisoprene polyol, hydrogenated polyisoprene polyol and the like. Of these, hydrogenated polyisoprene polyol and polyisoprene polyol are preferable, in view of the compatibility with polyolefin and influence on the release force.

In addition, polyolefin polyol preferably has a hydroxyl value (mg KOH/g) of not less than 20, in view of the strength and hardenability of the layer release agent. On the other hand, in view of the influence on the release force, it is preferably not more than 75. The hydroxyl value (mg KOH/g) is more preferably 25-60.

In the present invention, the polyolefin polyol can be a commercially available product. As such commercially available product, for example, Poly bdR-45HT (hydroxyl-terminated liquid polybutadiene: Mn=2800, hydroxyl value=46.6 mg KOH/g, manufactured by Idemitsu Kosan Co., Ltd.), Poly ip (hydroxyl-terminated liquid polyisoprene: Mn=2500, hydroxyl value=46.6 mg KOH/g, manufactured by Idemitsu Kosan Co., Ltd.), Epole (hydroxyl-terminated liquid hydrogenated polyisoprene: Mn=2500, hydroxyl value=50.5 mg KOH/g, manufactured by Idemitsu Kosan Co., Ltd.), GI-1000 (hydroxy group-containing liquid hydrogenated polybutadiene: Mn=1500, hydroxyl value=60-75 mg KOH/g, manufactured by Nippon Soda Co., Ltd.), GI-2000 (hydroxy group-containing liquid hydrogenated polybutadiene: Mn=2100, hydroxyl value=40-55 mg KOH/g, manufactured by Nippon Soda Co., Ltd.), GI-3000 (hydroxy group-containing liquid hydrogenated polybutadiene: Mn=3000, hydroxyl value=25-35 mg KOH/g, manufactured by Nippon Soda Co., Ltd.) and the like can be mentioned. All of these polyolefin polyols are liquid at ordinary temperature. In addition, UNISTOLE P-801 (16 wt % toluene solution of hydroxy group-containing polyolefin, toluene-free product thereof is a solid, hydroxyl value 40 mg KOH/g, manufactured by Mitsui Chemicals, Inc.) can also be used.

The content of polyolefin polyol in the release agent is set such that the value A in the following formula (I):

A=hydroxyl value (mg KOH/g) of polyolefin polyol×parts by weight of polyolefin polyol relative to 100 parts by weight of polyolefin (I)

is preferably 30-250, more preferably 40-200, further preferably 50-150. When the value A is smaller than 30, the strength of the release agent layer tends to be insufficient, and when it is more than 250, the release force of the release agent layer tends to be too high.

### [Metal Complex Catalyst]

The release agent of the present invention is characterized by containing a metal complex catalyst of a non-organotin compound as a urethane catalyst. Only one kind of the metal complex catalyst may be used or two or more kinds thereof may be used in combination. The “organotin compound” in the present invention means a compound or salt having a tin-carbon (Sn—C) bond and includes, for example, dibutyltin dilaurate, dibutyltin dilaurate and the like. On the other hand, the “non-organotin compound” means a compound or salt having no tin-carbon bond.

The “metal complex” in the present invention is a compound or salt having a central metal and a ligand, wherein these are bonded by a coordinate bond. This metal complex does not include a simple metal salt free of a coordinate bond, for example, metal carboxylate. The metal complex having a coordinate bond can show superior solubility in an organic solvent as compared to metal salts formed only by an ionic bond. The metal carboxylate shows bad solubility in an organic solvent as well as poor solubility in a release agent component. Therefore, the appearance of a coated surface sometimes becomes poor in a drying step of a coated release agent solution when metal carboxylate is used.

From the aspect of solubility in an organic solvent, the metal complex catalyst preferably has an organic ligand, more preferably a metal chelate catalyst. Here, the “metal chelate catalyst” means a compound or salt wherein a metal atom and an organic multidentate ligand form a chelate ring by a coordinate bond. The “chelate ring” refers to a ring structure wherein two or more coordinating atoms of an organic multidentate ligand coordinate to the central metal, such that the coordinating atoms sandwich the central metal. Examples of the metal chelate catalyst include an acetylacetonato metal complex wherein acetylacetone coordinates to the central metal and the like.

The metal complex catalyst promotes a urethane reaction of isocyanate and polyolefin polyol, and acts to form a release agent layer superior in adhesion to a substrate. For promotion of this reaction, the metal complex catalyst is preferably at least one selected from the group consisting of a titanium complex catalyst, a zinc complex catalyst, a zirconium complex catalyst, an aluminum complex catalyst and an iron complex catalyst, more preferably at least one selected from the group consisting of a titanium complex catalyst, a zinc complex catalyst, a zirconium complex catalyst and an aluminum complex catalyst. These titanium complex catalyst, zinc complex catalyst, zirconium complex catalyst, aluminum complex catalyst and iron complex catalyst are preferably metal chelate catalysts.

Various metal complex catalysts are commercially available, and a commercially available metal complex catalyst may be used in the present invention. In addition, various organic ligands, particularly various multidentate ligands capable of forming metal chelate catalysts, are commercially available. Hence, a metal complex catalyst prepared by combining a commercially available organic ligand and a metal may also be used.

Examples of the commercially available metal complex catalyst include titanium chelate catalysts such as Orgatix TC-100 (titanium diisopropoxy bis(acetylacetonate)), Orgatix TC-401 (titanium tetraacetylacetonate), Orgatix TC-200 (titanium dioctyloxy bis(octyleneglycolate)) and Orgatix TC-750 (titanium diisopropoxy bis(ethyl acetoacetate)); zirconium chelate catalysts such as Orgatix ZC-150 (zirconium tetraacetylacetonate, powder type), Orgatix ZC-700 (zirconium tetraacetylacetonate, solution), Orgatix ZC-540 (zirconium tributoxy monoacetylacetonate), Orgatix ZC-570 (zirconium monobutoxy acetylacetonate bis(ethyl acetoacetate)) and Orgatix ZC-580 (zirconium dibutoxy bis(ethyl acetoacetate)); and aluminum chelate complexes such as Orgatix AL-80 (aluminum trisacetylacetonate), which are available from Matsumoto Trading Co., Ltd., and the like. Of these, Orgatix TC-401, Orgatix ZC-150 and Orgatix ZC-700 are preferable, and Orgatix TC-401 are more preferable.

In addition, examples of the commercially available metal complex catalyst include zirconium chelate catalysts such as K-KAT 4205 (zirconium acetylacetonate complex) and K-KAT A209 (zirconium (6-methyl-2,4-heptadionate) complex); zinc amine catalysts such as K-KAT XK-614 and K-KAT XK-622; and aluminum chelate catalysts such as K-KAT 5218 (aluminum bis(ethyl acetoacetate)monoacetylacetonate), which are manufactured by KING INDUSTRIES, and the like. Of these, K-KAT 4205, K-KAT A209, K-KAT XK-614 and K-KAT 5218 are preferable, K-KAT 4205, K-KAT A209 and K-KAT 5218 are more preferable, and K-KAT A209 is further preferable.

Moreover, examples of the commercially available metal complex catalyst include SUNNYCAT TC-100 (diisopropoxytitanium bis(ethyl acetoacetate), which is also called titanium diisopropoxy bis(ethyl acetoacetate)) manufactured by Nitto Kasei Co., Ltd.; titanium tetraacetylacetone (also called titanium tetraacetylacetate), titanium tetraheptanedione (also called titanium tetrakis (tetramethylheptanedionate)), zirconium tetraacetylacetone (also called zirconium tetraacetylacetate), zirconium tetramethylheptanedione, iron acetylacetone (also called iron(III) trisacetylacetonate) and iron tetramethylheptanedione (also called iron(III) tris(tetramethylheptanedionate)), which are manufactured by Yamanaka Hutech Corporation; ALCH (aluminum(ethyl acetoacetate)diisopropylate), ALCH-TR (aluminum tris(ethylacetoacetate)), Alumichelate M (aluminum (alkylacetoacetate)diisopropylate), Alumichelate D (aluminum bis(ethyl acetoacetate)mono(acetylacetonate)) and Alumichelate A(W) (aluminum tris(acetylacetonate)), which are manufactured by Kawaken Fine Chemicals Co., Ltd.; tris(ethyl acetoacetato)aluminum (also called aluminum tris(acetylacetonate)), tetrakis(2,2,6,6-tetramethyl-3,5-heptanedionato)zirconium(IV), iron(III) acetylacetonate and tris(2,2,6,6-tetramethyl-3,5-heptanedionato)iron(III), which are manufactured by Wako Pure Chemical Industries, Ltd.; and Nacem Aluminium (aluminum tris(acetylacetonate)), Nacem Zirconium (zirconium tetrakis(acetylacetonate)), Nacem Titanium (titanium dibutoxy bis(acetylacetonate)) and Nacem Ferric Iron (iron(III) trisacetylacetonate), which are manufactured by NIHON KAGAKU SANGYO CO., LTD., and the like.

The content of the metal complex catalyst in the release agent is preferably 0.1-2.5 parts by weight, more preferably 0.2-2.0 parts by weight, further preferably 0.3-1.5 parts by weight, relative to 100 parts by weight of polyolefin. When the content is less than 0.1 part by weight, the catalyst action sometimes becomes insufficient. When the content exceeds 2.5 parts by weight, troubles such as a high release force of the release agent layer and shortening of the pot life of the release agent sometimes occur.

The content of the metal complex catalyst here indicates an amount of only a metal complex catalyst. For example, when a catalyst solution obtained by dissolving a metal complex catalyst in a solvent, such as “K-KAT 4205” to be used in the below-mentioned Examples is used, the content means the amount of only a metal complex catalyst except the amount of the solvent.

### [Optional Component]

The release agent of the present invention may contain one or more kinds of optional components. For example, when a release agent layer having a low release force is desired, one or more kinds of liquid hydrocarbons may be used as optional components in the release agent. Here, the “liquid hydrocarbon” in the present invention means a hydrocarbon having a viscosity at 38° C. of 5-1500 Pa·s, which is measured according to JIS K7117-1:1990 (hereinafter sometimes to be abbreviated as “38° C. viscosity”). Using such liquid hydrocarbon, the rate dependency of the release force of the release agent layer can be decreased without decreasing the adhesive force of the adhesive tape.

The 38° C. viscosity of the liquid hydrocarbon is generally 5-1500 Pa·s, preferably 5-1300 Pa·s. When the 38° C. viscosity is less than 5 Pa·s, the rate dependency of the release force sometimes does not decrease sufficiently. When the amount of the liquid hydrocarbon having a 38° C. viscosity of less than 5 Pa·s is increased to sufficiently decrease the rate dependency of the release force, the adhesive force of the adhesive tape decreases. On the other hand, when the 38° C. viscosity exceeds 1500 Pa·s, the flowability of the liquid hydrocarbon decreases at around 10-30° C., which is the assumed temperature of use of a release material and an adhesive tape, and therefore, the rate dependency of the release force sometimes does not decrease sufficiently.

Examples of the liquid hydrocarbon include unsaturated hydrocarbon polymer and the like. Here, the “unsaturated hydrocarbon polymer” in the present invention is used to mean not only polymers but also oligomers. From the aspect of compatibility, liquid hydrocarbon is preferably at least one selected from the group consisting of a liquid copolymer of ethylene and a unsaturated hydrocarbon having 3-5 carbon atoms, a liquid homopolymer of an unsaturated hydrocarbon carbon having 3-5 carbon atoms and a liquid copolymer of an unsaturated hydrocarbon having 3-5 carbon atoms. Examples of the unsaturated hydrocarbon having 3-5 carbon atoms include propylene, 1-butene, isobutene, 2-butene, butadiene, 1-pentene, 2-pentene, isopentene, isoprene and the like. The liquid hydrocarbon is more preferably at least one selected from the group consisting of a liquid ethylene-olefin copolymer, liquid polybutadiene, liquid polyisoprene, liquid hydrogenated polybutadiene, liquid hydrogenated polyisoprene and liquid polyisobutene. The liquid hydrocarbon can be produced by a known method, for example, radical polymerization or cationic polymerization and the like.

As liquid hydrocarbon, a commercially available product may be used. Examples of the commercially available liquid hydrocarbon include LUCANT HC-600 (38° C. viscosity=8.5 Pa·s), HC-2000 (38° C. viscosity=34 Pa·s) (all above manufactured by Mitsui Chemicals, Inc.), KURAPRENE LIR-30 (38° C. viscosity=74 Pa·s), LIR-50 (38° C. viscosity=480 Pa·s), LIR-290 (38° C. viscosity=1000 Pa·s), LBR-300 (38° C. viscosity=280 Pa·s) (all above manufactured by KURARAY CO., LTD.), Nisseki polybutene HV-100, HV-300, HV-1900 (all above manufactured by NIPPON OIL CORPORATION), Nissan polybutene 10N, 30N, 200N (all above manufactured by NOF CORPORATION) and the like.

When liquid hydrocarbon is used, the content thereof in the release agent is preferably 3-30 parts by weight, more preferably 4-20 parts by weight, further preferably 5-15 parts by weight, relative to a total 100 parts by weight of polyolefin and liquid hydrocarbon. When the content is less than 3 parts by weight, the peel rate dependency sometimes does not decrease sufficiently. Conversely, when it exceeds 30 parts by weight, the strength of the release agent layer sometimes decreases, and the adhesive force of an adhesive tape sometimes decreases due to the transfer of the liquid hydrocarbon to the adhesive layer of the adhesive tape.

Where necessary, the release agent of the present invention may contain resin other than the aforementioned polyolefin, antioxidant, UV absorber, light stabilizer such as hindered amine light stabilizer and the like, antistatic agent, fillers, pigments such as carbon black, calcium oxide, magnesium oxide, silica, zinc oxide, titanium oxide etc., and the like.

### 2. Release Material

The present invention also provides a release material having a substrate and a release agent layer. The release material of the present invention is characterized by having a release agent layer formed from the release agent of the present invention on at least one surface of the substrate. The substrate and the release agent layer are explained in order in the following.

### [Substrate]

Although the substrate in the present invention is not particularly limited, the substrate is preferably a plastic film because it has a smooth surface. Examples of the plastic film include polyester films such as poly(ethylene terephthalate) film and poly(butylene terephthalate) film and polyolefin films such as polyethylene film and polypropylene film. Paper such as craft paper, glassine paper, or fine paper may be used as the substrate. As the paper substrate, preference is given to one laminated with a plastic such as polyethylene or sealed up in order to prevent the release agent from impregnating the substrate in excess. The substrate may be subjected to a corona treatment, plasma treatment, flame treatment and the like in advance as necessary.

The thickness of the substrate is not particularly limited, and can be appropriately determined depending on the object of use. When a plastic film is used as a substrate, the thickness thereof is generally about 12-250 μm, preferably 16-200 μm, more preferably 25-125 μm.

In addition, the substrate may contain, where necessary, antioxidant, UV absorber, light stabilizer such as hindered amine light stabilizer and the like, antistatic agent, fillers, pigments such as carbon black, calcium oxide, magnesium oxide, silica, zinc oxide, titanium oxide etc., and the like.

### [Release Agent Layer]

The release agent layer is obtained by dissolving the release agent of the present invention in an organic solvent to prepare a release agent solution, applying the obtained release agent solution to a substrate, and drying same.

Only one kind of the organic solvents may be used or two or more kinds thereof may be used in combination. The content of the organic solvent is preferably adjusted within the range of 95-99.9 wt % in the release agent solution.

The organic solvent is not particularly limited as long as the release agent can be uniformly dissolved. However, since the release agent of the present invention contains polyolefin as an essential component, the organic solvent is preferably only one kind of hydrocarbon solvent, a mixed solvent of two or more kinds of hydrocarbon solvents, or a mixed solvent of a hydrocarbon solvent and other solvent. When a mixed solvent is used, the content of the hydrocarbon solvent is preferably not less than 50 wt %, more preferably not less than 70 wt %, further preferably not less than 90 wt %, in the mixed solvent. Examples of the hydrocarbon solvent include aliphatic hydrocarbons such as normal hexane, normal heptane and the like, alicyclic hydrocarbons such as cyclohexane and the like, aromatic hydrocarbons such as toluene, xylene and the like. Examples of other solvent include ketones such as methyl ethyl ketone, cyclohexanone, acetylacetone and the like, esters such as ethyl acetate and the like, alcohols such as methanol, ethanol, isopropyl alcohol, tert-butyl alcohol and the like, and the like. From the aspect of an improved pot life of the release agent solution, a mixed solvent of hydrocarbon solvent and acetylacetone, and a mixed solvent of hydrocarbon solvent and tert-butyl alcohol are preferable.

The application method of the release agent solution is not particularly limited and any known method, for example, a method using a kiss-roll coater, a bead coater, a rod coater, a Mayer bar coater, a die coater, a gravure coater and the like can be used. Also, the drying method is not particularly limited, and any known method can be used. A general drying method is hot air drying. While the temperature for the hot air drying varies depending on the heat resistance of the substrate, it is generally about 80-150° C.

The thickness of the release agent layer after drying is preferably 30-500 nm, more preferably 45-400 nm, further preferably 60-300 nm. When the thickness is less than 30 nm, the release force of the release agent layer sometimes becomes too large. Conversely, when it exceeds 500 nm, a problem of easy blocking of a substrate and a release agent layer that come into contact when the release material is wound in the form of a roll, and a problem of high release force of a release agent layer sometimes occur.

In the release material, other layer may be formed between the release agent layer and the substrate as long as the release agent layer is present on the outermost surface. The release agent layer is preferably directly formed on the substrate.

3. Adhesive Tape with Release Material

The present invention also provides an adhesive tape having an adhesive layer and the release material of the present invention, wherein the adhesive layer is in contact with the release agent layer of the release material.

The adhesive to be used for forming an adhesive layer is not particularly limited. Examples of the adhesive include rubber-based adhesives, acrylic adhesives, polyester-based adhesives and the like. Of these, acrylic adhesives and polyester-based adhesives are preferable. An adhesive tape with a release material, wherein the adhesive layer is formed using an acrylic adhesive and a polyester-based adhesive, shows stable releasability.

An acrylic adhesive can be prepared by using an acrylic polymer obtained by a commonly used method of polymerization such as solution polymerization, emulsion polymerization, or UV polymerization as a base resin, with various additives such as crosslinking agents, tackifiers, softening agents, antiaging agents, and fillers added thereto as required.

Examples of the acrylic polymer include a copolymer of a monomer mixture containing alkyl(meth)acrylate such as butyl(meth)acrylate, 2-ethylhexyl(meth)acrylate and the like as a main component, and, where necessary, other monomer as a copolymerizable modifying monomer (e.g., hydroxy group-containing monomer such as 2-hydroxyethyl(meth)acrylate and the like, carboxy group-containing monomer such as (meth)acrylic acid and the like, styrene-based monomer such as styrene and the like, vinyl esters such as vinyl acetate etc., and the like).

Examples of the polyester-based adhesive include an adhesive containing, as a base resin, a polyester-based polymer containing aliphatic carbonate diol (e.g., carbonate diol obtained by the reaction of a diol component such as butanediol and the like and a carbonate compound such as ethylenecarbonate and the like, and the like) as an inherent polyol component.

The adhesive layer can be formed by applying, for example, an adhesive solution to the release agent layer of the release material, and drying. In addition, an adhesive solution may be applied onto a substrate other than the substrate of the release material and dried to form an adhesive layer, and this may be adhered to a release agent layer of the release material. Furthermore, an adhesive layer of the release material may be formed by adhering a commercially available adhesive tape to the release agent layer of the release material. The thickness of the adhesive layer can be appropriately determined in consideration of the adhesiveness and the like, and it is preferably 3-100 μm, more preferably 5-90 μm, further preferably 10-80 μm.

4. Adhesive Tape with Release Agent Layer

The present invention also provides an adhesive tape having a substrate, an adhesive layer and a release agent layer. The adhesive tape of the present invention is characterized in that it has a release agent layer, which is formed from the release agent of the present invention, on one surface of the substrate, and an adhesive layer on the other surface of the substrate on which a release agent layer is not formed. In the following, the release agent layer of this embodiment is sometimes referred to as a “treated back face layer”, and the adhesive tape of this embodiment is sometimes referred to as an “adhesive tape with a treated back face layer”.

The adhesive tape with a treated back face layer may assume any of a roll-like wound form and a stacked sheet form. In both forms, the adhesive layer is protected by a treated back face layer.

In the adhesive tape with a treated back face layer, the adhesive layer and the treated back face layer may be directly formed on a substrate, and other layer may be formed between these layers and the substrate. However, both the adhesive layer and the treated back face layer need to be present on the outermost surface. In this way, when the adhesive tape is wound like a roll, or the adhesive tape in a sheet form is laminated, the adhesive layer can be protected by the treated back face layer in contact with the adhesive layer. Both the adhesive layer and the treated back face layer are preferably directly formed on a substrate.

The adhesive to be used for forming an adhesive layer of the adhesive tape with a treated back face layer is not particularly limited. Examples of the adhesive therefor include those explained for the adhesive tape with a release material and the like. In addition, as a method for forming the adhesive layer, a method similar to those explained for the adhesive tape with a release material can be adopted.

As a method for forming the treated back face layer, a method similar to those explained for the adhesive tape with a release material can be adopted. The thickness of the treated back face layer is preferably 30-500 nm, more preferably 45-400 nm, most preferably 60-300 nm, from the aspect of the release force.

### 5. Physical Properties, Characteristics and the Like

In the present specification, the physical property, characteristics and the like are measured by the following methods.

(1) density

A value measured according to ASTM D1505

(2) melt flow rate (230° C.)

A value measured according to ASTM D1238

(3) number-average molecular weight

A value measured according to ASTM D2503

(4) hydroxyl value

A value measured according to JIS K1557:1970

### EXAMPLES

The present invention is hereinafter described more specifically by means of the following Examples and Comparative Examples, which, however, do not limit the scope of the invention. In the following, “parts” and “%” show “parts by weight” and “wt %”, respectively, unless otherwise specified.

### 1. Release Agent Component

The release agent components used in the Examples and Comparative Examples are described in the following.

### (1) Polyolefin

TAFMER P-0280 (ethylene-propylene copolymer (ethylene: 87 mol %, propylene: 13 mol %), manufactured by Mitsui Chemicals, Inc., MFR (230° C.): 5.4 g/10 min, density: 0.87 g/cm³, tensile modulus of elasticity at 23° C.: 5.1 MPa, tensile breaking stress at 23° C.: 3.3 MPa)

TAFMER A-35070S (ethylene-1-butene copolymer (ethylene: 85 mol %, 1-butene: 15 mol %), manufactured by Mitsui Chemicals, Inc., MFR (230° C.): 65 g/10 min, density: 0.87 g/cm³, tensile modulus of elasticity at 23° C.: 3.5 MPa, tensile breaking stress at 23° C.: 2.1 MPa)

### (2) Polyolefin Polyol

Epole (hydroxyl-terminated liquid hydrogenated polyisoprene, Mn: 2500, hydroxyl value: 50.5 mg KOH/g, manufactured by Idemitsu Kosan Co., Ltd.)

### (3) Isocyanate

CORONATE L (75% solution of adduct of tolylene diisocyanate and trimethylolpropane in ethyl acetate, isocyanate group number in one molecule: 3, manufactured by Nippon Polyurethane Industry Co., Ltd.)

TAKENATE D110N (75% solution of adduct of xylylene diisocyanate and trimethylolpropane in ethyl acetate, isocyanate group number in one molecule: 3, manufactured by Mitsui Chemicals, Inc.)

### (4) Liquid Hydrocarbon

LUCANT HC-2000 (ethylene-α-olefin co-oligomer, 38° C. viscosity: 34 Pa·s, manufactured by Mitsui Chemicals, Inc.)

(5) Metal Complex Catalyst K-KAT 4205 (solution of zirconium acetylacetonate complex in acetylacetone, metal complex content: about 1%, manufactured by KING INDUSTRIES)

K-KAT A209 (solution of zirconium (6-methyl-2,4-heptanedionate) complex, metal complex content: about 14%, manufactured by KING INDUSTRIES)

K-KAT XK-614 (zinc amine catalyst, manufactured by KING INDUSTRIES)

K-KAT 5218 (solution of aluminum bis(ethyl acetoacetate)monoacetylacetonate in polyglycol and acetylacetone, metal complex content: about 63%, manufactured by KING INDUSTRIES)

Orgatix TC-401 (solution of titanium tetraacetylacetonate in isopropyl alcohol, metal complex content: about 65%, available from Matsumoto Trading Co., Ltd.)

Nacem Ferric Iron (iron (III) trisacetylacetonate, manufactured by NIHON KAGAKU SANGYO CO., LTD.)

(6) Catalysts Other than Metal Complex Catalysts

dibutyltin (IV) dilaurate (dibutyltin dilaurate manufactured by Wako Pure Chemical Industries, Ltd.)

triethylenediamine (manufactured by NACALAI TESQUE, INC.)

PUCAT 25 (solution of bismuth octylate in octylic acid, bismuth content: 25%, manufactured by NIHON KAGAKU SANGYO CO., LTD.)

NAPHTHEX Zr (solution of zirconium naphthenate in mineral spirit, zirconium content: 4%, manufactured by NIHON KAGAKU SANGYO CO., LTD.)

NIKKA OCTHIX Zn (solution of zinc octylate in mineral spirit, zinc content: 15%, manufactured by NIHON KAGAKU SANGYO CO., LTD.)

### (7) Organic Solvents

toluene

tert-butyl alcohol

acetylacetone

### 2. Preparation of Release Agent Solution

Respective components in the number of parts shown in Tables 1 and 2 were mixed, and the mixtures were dissolved in toluene in Examples 1-6 and Comparative Examples 1-5, in a mixed solvent of toluene and tert-butyl alcohol (weight ratio of toluene/tert-butyl alcohol=95/5) in Examples 7 and 10, and in a mixed solvent of toluene and acetylacetone (weight ratio of toluene/acetylacetone=99.1/0.9) in Examples 8, 9 and 11, to prepare release agent solutions having a solid content of 1.5%. The number of parts of the catalysts shown in Tables 1 and 2 is that of the obtained catalyst itself and, when the obtained catalyst is a solution, it is the number of parts of the whole catalyst solution.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|
| polyolefin | TAFMER P-0280 | 80 | 80 | 80 | 80 | 80 | 75 | 75 | 75 | 75 | 70 | 70 |
| (parts) | TAFMER A-35070S | 20 | 20 | 20 | 20 | 20 | 20 | 20 | 20 | 20 | 30 | 30 |
| polyolefin polyol | Epole | 1 | 1 | 1 | 1 | 1 | 1 | 1 | 1 | 1 | 1 | 1 |
| (parts) | | | | | | | | | | | | |
| isocyanate (parts) | CORONATE L | 3 | 3 | | 3 | 3 | 3 | 2 | 2 | 2 | 2 | 2 |
| | TAKENATE D110N | | | 3 | | | | | | | | |
| liquid | LUCANT HC-2000 | | | | | | 5 | 5 | 5 | 5 | | |
| hydrocarbon (parts) | | | | | | | | | | | | |
| catalyst | K-KAT 4205 | 80 | | | | | | | | | | |
| (parts) | K-KAT A209 | | 1.0 | | | | 1.0 | 1.0 | 1.0 | | | |
| | K-KAT XK-614 | | | 1.0 | | | | | | | | |
| | Orgatix TC-401 | | | | 1.0 | | | | | 1.0 | | |
| | K-KAT 5218 | | | | | 2.0 | | | | | | |
| | Nacem Ferric | | | | | | | | | | 0.1 | 0.3 |
| | Iron | | | | | | | | | | | |

(Note)
The number of parts of the catalyst is that of the obtained catalyst itself (when the catalyst is a catalyst solution, it also includes the organic solvent thereof).
K-KAT 4205, K-KAT A209: Zr complex catalyst, K-KAT XK-614: Zn complex catalyst, Orgatix TC-401: Ti complex catalyst, K-KAT 5218: Al complex catalyst, Nacem Ferric Iron: Fe complex catalyst

TABLE 2

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| polyolefin | TAFMER P-0280 | 80 | 80 | 80 | 80 | 80 |
| (parts) | TAFMER A-35070S | 20 | 20 | 20 | 20 | 20 |
| polyolefin | Epole | 1 | 1 | 1 | 1 | 1 |
| polyol | | | | | | |
| (parts) | | | | | | |
| isocyanate | CORONATE L | 3 | 3 | 3 | 3 | 3 |
| (parts) | | | | | | |
| catalyst (parts) | dibutyltin(IV) | 0.2 | | | | |
| | dilaurate | | | | | |
| | triethylenediamine | | 1.0 | | | |
| | PUCAT 25 | | | 1.0 | | |
| | (Bi octylate) | | | | | |
| | NAPHTHEX Zr | | | | 2.0 | |
| | (Zr naphthenate) | | | | | |
| | NIKKA OCTHIX | | | | | 2.0 |
| | Zn | | | | | |
| | (Zn octylate) | | | | | |

(Note)
The number of parts of the catalyst is that of the obtained catalyst itself (when the catalyst is a catalyst solution, it also includes the organic solvent thereof)

### 3. Formation of Release Agent Layer (Preparation of Release Material)

The prepared release agent was applied to a 38 μm-thick polyester film with a Mayer bar #6, and heated by a hot air dryers at 130° C.×1 min to give a release material. The thickness of the release agent layer of the obtained release material was about 150 nm.

### 4. Property Evaluation of Catalyst and Release Agent Layer

The properties of the catalysts used (i.e., whether or not a non-organotin compound, and solubility in toluene) are described in Tables 3 and 4. In addition, Tables 3 and 4 also describe the properties of the obtained release agent layer. The evaluation methods of the solubility of the catalyst in toluene and the properties of the release agent layer are described below.

### (1) Solubility of Catalyst in Toluene

Each catalyst used was diluted 500 weight fold with toluene to give a solution. The diluted solution was left standing at 23° C. for 24 hr, the appearance thereof was visually observed, and the solubility in toluene was evaluated according to the following criteria.

◯: Diluted solution after standing showed no change from immediately after dilution, and was uniform and transparent.

x: Diluted solution after standing showed precipitates such as deposit, suspended matter and the like.

### (2) Appearance of Release Agent Layer

The appearance of the formed release agent layer was visually evaluated according to the following criteria.

◯: Nonuniformity and cissing are absent, and the release agent layer is uniform.

x: streaky, spotted or unstructured nonuniformity and cissing are present, and the release agent layer is nonuniform.

### (3) Adhesion of Release Agent Layer to Substrate

The surface of the release agent layer was rubbed 3 strokes with a finger and the condition was evaluated according to the following criteria.

◯: No change or the surface assumes whitish cloudy state, but no falling off of release agent layer.

x: Release agent layer falls off in flakes to yield chaff like the one produced by rubbing an eraser, and the substrate is exposed.

### (4) Ordinary Release Force of Release Agent Layer

A 25 mm-width acrylic adhesive tape No. 31B (manufactured by NITTO DENKO CORPORATION) was adhered to a surface of a release agent layer by a hand roller, and preserved at 23° C. for 24 hr. The release material was pulled by a tensile tester in the 180° direction at a rate of 3.0 m/min, and the ordinary release force was measured under a 23° C. atmosphere.

(5) Release Force after Heating of Release Agent Layer

A 25 mm-width acrylic adhesive tape No. 31B (manufactured by NITTO DENKO CORPORATION) was adhered to a surface of a release agent layer by a hand roller, heated at 70° C. for 24 hr, and cooled at 23° C. for 1-2 hr. The release material was pulled by a tensile tester in the 180° direction at a rate of 3.0 m/min, and the release force after heating was measured under a 23° C. atmosphere.

TABLE 3

| | | | | | | | | | | | Ex. | Ex. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | 10 | 11 |
| catalyst | non-organotin compound | ◯ | ◯ | ◯ | ◯ | ◯ | ◯ | ◯ | ◯ | ◯ | ◯ | ◯ |
| | solubility in toluene | ◯ | ◯ | ◯ | ◯ | ◯ | ◯ | ◯ | ◯ | ◯ | ◯ | ◯ |
| release | appearance | ◯ | ◯ | ◯ | ◯ | ◯ | ◯ | ◯ | ◯ | ◯ | ◯ | ◯ |
| agent | adhesion to substrate | ◯ | ◯ | ◯ | ◯ | ◯ | ◯ | ◯ | ◯ | ◯ | ◯ | ◯ |
| layer | ordinary release force | 0.58 | 0.56 | 0.53 | 0.60 | 0.57 | 0.30 | 0.31 | 0.31 | 0.30 | 0.55 | 0.55 |
| | (N/25 mm) | | | | | | | | | | | |
| | release force after | 0.60 | 0.55 | 0.54 | 0.59 | 0.55 | 0.32 | 0.34 | 0.33 | 0.32 | 0.58 | 0.60 |
| | heating (N/25 mm) | | | | | | | | | | | |

TABLE 4

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| catalyst | non-organotin | X | ◯ | ◯ | ◯ | ◯ |
| | compound | | | | | |
| | solubility in | ◯ | ◯ | X | ◯ | ◯ |
| | toluene | | | | | |
| release | appearance | ◯ | ◯ | X | ◯ | X |
| agent | adhesion to | ◯ | X | X | X | X |
| layer | substrate | | | | | |
| | ordinary | 0.59 | 0.57 | 0.94 | 0.80 | 0.75 |
| | release force | | | | | |
| | (N/25 mm) | | | | | |
| | release force | 0.58 | 0.65 | 5.75 | 1.53 | 1.35 |
| | after heating | | | | | |
| | (N/25 mm) | | | | | |

As shown in Tables 3 and 4, in Examples 1-11 using a metal complex catalyst (non-organotin compound), like Comparative Example 1 using an organotin compound as a catalyst, release agent layers having superior property were obtained. In contrast, in Comparative Example 2 using triethylenediamine as a catalyst, and Comparative Examples 3-5 using a metal carboxylatese as a catalyst, only a release agent layer inferior in adhesion to a substrate could be formed. In addition, the release agent layers of Comparative Examples 3 and 5 had bad appearance. Moreover, release agent layers of Comparative Examples 3-5 showed a high release force.

### INDUSTRIAL APPLICABILITY

The release agent of the present invention can form a release agent layer superior in the property, without using an organotin compound which is environmentally problematic. A release material and an adhesive tape having such release agent layer can be preferably used for various applications in relation to electronic components and the like.

1. A release agent comprising polyolefin, isocyanate, polyolefin polyol and a metal complex catalyst, wherein the metal complex catalyst is a non-organotin compound.

2. The release agent according to claim 1, wherein the metal complex catalyst has an organic ligand.

3. The release agent according to claim 2, wherein the metal complex catalyst is a metal chelate catalyst.

4. The release agent according to claim 1, wherein the metal complex catalyst is at least one selected from the group consisting of a titanium complex catalyst, a zinc complex catalyst, a zirconium complex catalyst, an aluminum complex catalyst and an iron complex catalyst.

5. The release agent according to claim 1, wherein the isocyanate is polyisocyanate having 3 or more isocyanate groups in one molecule.

6. The release agent according to claim 5, wherein the polyisocyanate is at least one selected from the group consisting of aromatic polyisocyanate and alicyclic polyisocyanate.

7. The release agent according to claim 6, wherein the polyisocyanate is at least one selected from the group consisting of an adduct of aromatic diisocyanate and polyvalent alcohol and an adduct of alicyclic diisocyanate and polyvalent alcohol.

8. The release agent according to claim 1, wherein the polyolefin polyol has a number-average molecular weight of 1500-50000.

9. A release material having a substrate and a release agent layer, wherein the release agent layer is formed from the release agent according to claim 1 and is formed on at least one surface of the substrate.

10. An adhesive tape having an adhesive layer and the release material according to claim 9, wherein the adhesive layer is in contact with the release agent layer of the release material.

11. An adhesive tape having a substrate, an adhesive layer and a release agent layer, wherein the release agent layer is formed from the release agent according to claim 1, and is formed on at least one surface of the substrate, and the adhesive layer is formed on the other surface of the substrate free of the release agent layer.

12. The release agent according to claim 4, wherein the isocyanate is polyisocyanate having 3 or more isocyanate groups in one molecule which is at least one selected from the group consisting of an adduct of aromatic diisocyanate and polyvalent alcohol and an adduct of alicyclic diisocyanate and polyvalent alcohol.

13. The release agent according to claim 4, wherein the polyolefin polyol has a number-average molecular weight of 1500-50000.

14. The release agent according to claim 7, wherein the polyolefin polyol has a number-average molecular weight of 1500-50000.

15. The release agent according to claim 12, wherein the polyolefin polyol has a number-average molecular weight of 1500-50000.
